(19) United States
(12) Patent Application Publication
(10) Pub. No.: US 2025/0377078 A1
(43) Pub. Date: Dec. 11, 2025

(54) SUPPORT STRUCTURE FOR A STORAGE TANK

(71) Applicant: GAZTRANSPORT ET TECHNIGAZ, Saint Remy Les Chevreuse (FR)

(72) Inventor: Lu CHAO, Saint Remy Les Chevreuse (FR)

(73) Assignee: GAZTRANSPORT ET TECHNIGAZ, Saint Remy Les Chevreuse (FR)

(21) Appl. No.: 18/876,513

(22) PCT Filed: Jun. 9, 2023
(86) PCT No.: PCT/EP2023/065553

§ 371 Date: Dec. 18, 2024

(30) Foreign Application Priority Data
Jun. 28, 2022 (CN) 202210753047.X

(51) Int. Cl. F17C 13/08

(52) U.S. Cl. CPC F17C 13/081; F17C 2203/0304; F17C 2203/0636; F17C 2205/0184; F17C 2221/033; F17C 2221/035

(57) ABSTRACT

A support structure is configured to hold a storage tank by being located at least underneath the storage tank. The support structure includes at least a metallic structure and at least one pad including at least concrete mixed with a powdery material, the pad being superimposed on the metallic structure.

The present invention relates to the field of sealed and thermally insulated tanks for the storage and/or the transport of liquid cargo at low temperature, such as tanks for the transport of Liquefied Petroleum Gas (LPG), or liquid hydrogen (LH2), or carbon dioxide (CO2), or Ethane, or Ammoniac (NH3) or Liquefied Natural Gas (LNG). Such a LNG is transported in a liquid state when the LNG is a temperature below −163° C., at atmospheric pressure.

The sealed and thermally insulated tanks used for the storage of these liquids at low temperature are usually composed of an insulating mass and a metallic membrane, composed of a plurality of corrugated plates, coming into contact with the liquid. Usually, the insulating mass of the storage tank comprises at least a first thermal barrier and a second thermal barrier for the thermal insulation of the storage tank. The tanks can be installed on a land or on a floating structure. In the case wherein the storage tank is used on a land, a slab must be installed to hold the said storage tank.

The support structures currently used are composed of a raised foundation which hold the storage tank. The support structure of the prior art do not comprise a thermal insulation function and have only the function of support. Such a support structure is not optimum in that they cannot be used with storage tank which comprises only one thermal barrier. So, the support structure of the previous art doesn't allow to reduce the complexity of the storage tank's structure while maintaining optimal thermal performance. As a second drawback, such a known slab is built in situ, which may represent a problem when it comes to get the materials or when the construction is made in a country with high hourly rate.

An aim of the invention is to propose a support structure configured to hold a storage tank, such a support structure comprising thermal insulation's characteristics and being configured in a way that the building can be done elsewhere the final location of the tank.

The invention is directed to a support structure for a storage tank, the support structure is configured to hold the storage tank by being located at least underneath the storage tank, the support structure comprises at least a metallic structure and at least one pad comprising at least concrete mixed with a powdery material, the pad being superimposed on the metallic structure.

At least one advantage of the support structure according to the invention is that the powdery material comprised in the pad grants to the said pad a thermal insulation property. In other words, the support structure participates to the thermal insulation of the storage tank which it holds in case of an accidental scenario. For example, the powdery material could be perlite or glass marbles or clay granules.

The support structure of the invention is having another advantage is terms of impact of any leakage. In that situation, the thermal insulated pad is acting as a thermal barrier located between the tank and the metallic structure. It avoids the negative impact, like contraction, of the negative temperature of the cold cargo on the metallic structure.

It is understood that the metallic structure is like a metallic truss structure.

According to the invention, the support structure comprises one metallic sheet being located between the pad and the metallic structure.

The metallic sheet participates to separate and to attach the pad from the metallic structure. Moreover, the metallic sheet participates to the support of the pad on the metallic structure, having the function of a formwork for the concrete mixed with particles of powdery material. Also, the metallic sheet participates to the fixation of a metallic plate located on an upper face of the pad, by being used as an anchoring base for the said metallic plate.

According to the invention, the pad comprises an upper face opposite to a bottom face, the support structure comprising at least one metallic plate located on the upper face of the pad.

The metallic plate participates to the separation of the pad and the support structure from the storage tank which it embedded. Moreover, the metallic plate participates to the support of the pad on the metallic structure, by having the function of a formwork for the concrete mixed with particles of the powdery material.

According to the invention, the pad comprises a periphery side which joins its bottom face with its upper face, the support structure comprising at least a metallic band located on the periphery side of the pad. Such a metallic band, together with the metallic sheet and with the metallic plate, is defining a volume that is occupied by the concrete mixed with the powdery material.

According to the invention, the metallic sheet and/or the metallic band are made in low temperature carbon steel and the metallic plate is made of stainless steel.

According to the invention, the pad is bordered by the metallic sheet, the metallic plate and the metallic band.

According to the invention, the pad comprises at least one anchor stud which extends along a vertical direction of the support structure and such that the at least one anchor stud joins the metallic sheet with the metallic plate.

The vertical direction is the stacking direction of the pad and the metallic structure. More precisely, the upper face and the bottom face of the pad are opposite along the vertical direction of the support structure.

According to the invention, the support structure comprises a sealing material installed at the junction of the metallic sheet and the metallic band.

The sealing material make a waterproof junction between the metallic sheet and the metallic band.

According to the invention, the metallic sheet and the metallic band are joined together to form a formwork for the pad.

According to an example of the invention, the metallic sheet and/or the metallic plate is made of a plurality of metallic pieces positioned in a same plane and attached one another, for example by a welding process.

According to the invention, the metallic structure comprises a plurality of metal beams assembled together.

According to an example of the invention, the metal beams have a section which comprises an “I” shape.

According to the invention, the metal beams are made in an alloy of steel and carbon.

According to the invention, the support structure has a thickness between 500 mm and 2000 mm.

According to the invention, the pad has a thickness between 100 mm and 600 mm.

According to the invention, the metallic structure has a thickness between 400 mm and 1400 mm.

According to the invention, the pad comprises at least a steel reinforcement located inside the mixture of concrete and powdery material.

The invention is covering a storage structure comprising a storage tank able to store a liquid and the support structure according to the characteristics listed in the present document, the storage tank being hold by the support structure, the storage tank comprises at least a bottom wall in contact with the support structure.

The storage tank comprises at least a peripheral wall which delimitates, at least with the bottom wall, an internal space of the storage tank which dedicated to receive the liquid to be stored, and comprises also an upper wall which closes the said internal space.

According to the invention, at least the bottom wall of the storage tank comprises at least one thermal barrier covered by a metallic membrane, the metallic membrane being designed to be in contact with the liquid.

Other features, details and advantages of the invention will emerge more clearly on reading the description given below by way of indication, in relation to the drawings, in which:

FIG. 1 is a view of a storage structure according to the invention comprising a storage tank and a support structure;

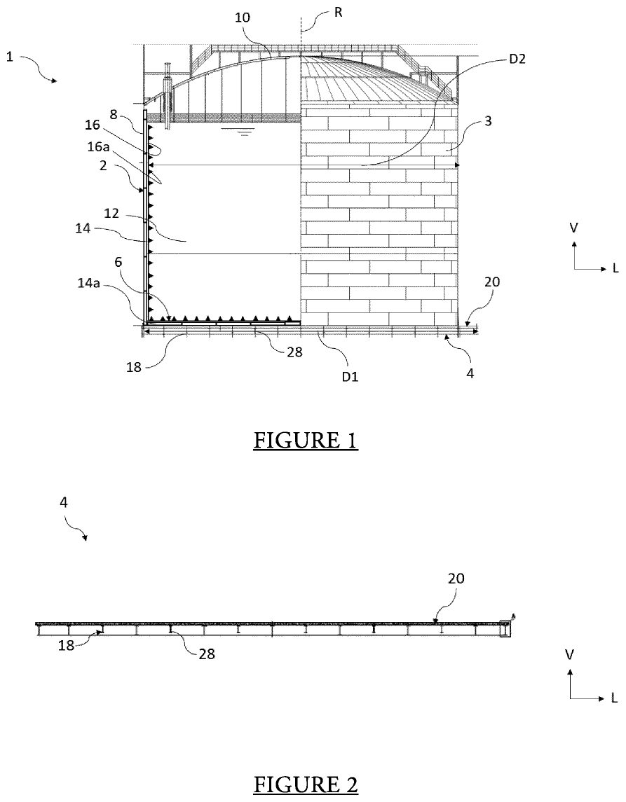

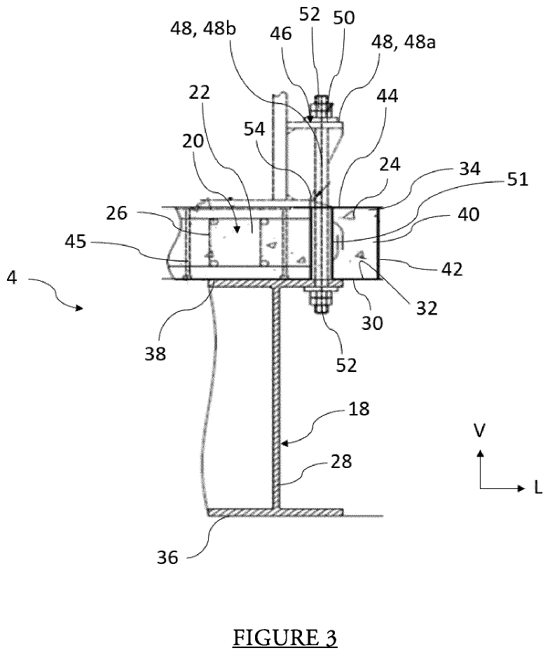

FIG. 2 is a view of the support structure of the storage structure of the FIG. 1;

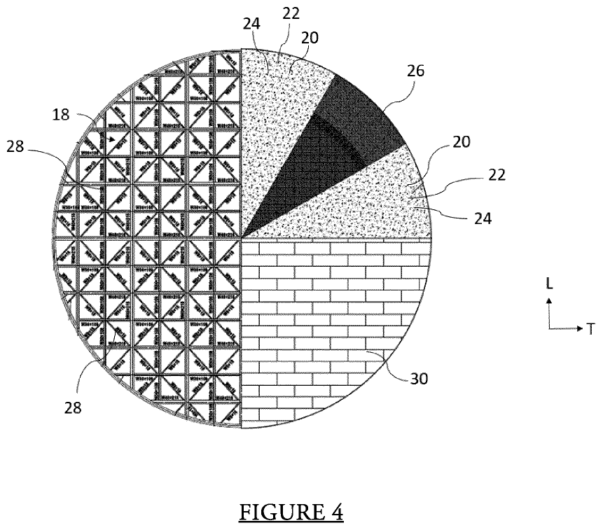

FIG. 3 is a closest view of a part of the support structure of the FIG. 2;

FIG. 4 is a top view of the support structure of the storage structure of the FIG. 1, showing each component of the support structure.

First of all, it should be noted that while the figures set out the invention in details for its implementation, these figures can of course be used to better define the invention, where appropriate. It should also be noted that these figures only show exemplary embodiments of the invention. Finally, the same references designate the same elements in all of the figures.

FIG. 1 shows a storage structure 1 comprising a storage tank 2 able to store a liquid, for example a gas in the liquid state like Liquid Natural Gas (LNG) or Liquefied Petroleum Gas (LPG). More precisely, FIG. 1 shows a cut-out view of the storage tank 2 with a left part of the FIG. 1 which shows the interior of the said storage tank 2 and a right part of the FIG. 1 which shows an outer wall 3 of the said storage tank 2. The storage structure 1 comprises also a support structure 4 according to the invention, configured to hold the storage tank 2 by being located underneath the said storage tank 2.

The storage tank 2 is made at least of a bottom wall 6, a peripheral wall 8 and an upper wall 10. The bottom wall 6 and the upper wall 10 are opposite each other along a vertical direction V of the support structure 4 and the peripheral wall 8 joins them. For example, the upper wall 10 may comprise a dome shaped roof. More precisely, the peripheral wall 8, the bottom wall 6 and the upper wall 10 define an internal space 12 configured to contain the liquid to be stored.

At least the bottom wall 6 comprises at least one thermal barrier 14 which allows the storage tank 2 to preserve the temperature of its liquid. This thermal barrier 14 comprises thermal insulation blocks 14a and a metallic membrane 16 which covers the said thermal insulation blocks 14a. More precisely, the metallic membrane 16 is configured to be in contact with the liquid store in the internal space of the storage tank 2.

According to an example of the invention, the metallic membrane 16 comprises at least one corrugation 16a that allow the said metallic membrane to absorb the deformations due to the variation of temperature inside the storage tank. The metallic membrane 16 can be made with a plurality of corrugated plates which comprise the characteristics describe above. Each of the corrugated plate comprises a plurality of first series of waves parallel to each other. The corrugated plate comprises also a plurality of second series of waves parallel to each other and extending perpendicular to the first series of waves. «Wave» means a deformation of the surface of the corrugated plate in the thickness of the plate.

The metallic membrane 16 is made of an anti-corrosion material, in particular stainless steel with a thickness for example between 0.5 mm and 2 mm, advantageously 1.2 mm.

The thermal barrier 14 of the bottom wall 6 is made so that it allows to preserve the temperature of the liquid stored in the internal space 12. According to an example of the invention, the thermal barrier 14 can be made of polyurethane foam or in any other material which brings thermal resistance to the said thermal barrier 14.

It is understood that the peripheral wall 8 and the upper wall 10 may comprise the same configuration and characteristics than the bottom wall 6 as describe above. So, it is understood from the description above that the peripheral wall 8, the bottom wall 6 and the upper wall 10 delimited the internal space 12 of the storage tank 2 which comprises the liquid and that the metallic membrane 16 of the peripheral wall 8 and the bottom wall 6 is configured to be in contact with the said liquid.

According to the invention, the storage tank 2 is held by the support structure 4 illustrated FIGS. 2 to 4, and more precisely at least the bottom wall 6 of the storage tank 2 is in contact with the support structure 4. FIG. 3 illustrates a closest view of the support structure 4 illustrated FIG. 2 and FIG. 4 illustrates a top view of the support structure 4 which show each part of its components from the bottom to the top in a counter-clockwise direction.

The support structure 4 comprises at least a metallic structure 18 and at least one pad 20 comprising at least concrete 22 mixed with a powdery material 24. The invention takes advantage of the composition of the pad 20 in that the powdery material 24 grants thermal properties to the said pad 20. In other words, the composition of the pad 20 with the powdery material 24 is acting as a thermal barrier located between the storage tank and the metallic structure 18. Such a composition of the pad 20 avoids the negative impact, like contraction, of the negative temperature of the cold cargo on the metallic structure 18. According to no limitative examples of the invention, the powdery material could be perlite or glass marbles or clay granules.

As show in FIG. 2, the pad 20 is superimposed on the metallic structure 18, in the vertical direction V of the support structure 4. Thus, it is understood that the pad 20 is located between the metallic structure 18 and the bottom wall 6 of the storage tank 2 according to the vertical direction V of the support structure 4.

As an element of the invention, the support structure 4 has a thickness between 500 mm and 2000 mm, the thickness being measured along the vertical direction V of the support structure 4.

According to the invention, the pad 20 has a thickness between 100 mm and 600 mm, the thickness being measured along the vertical direction V of the support structure 4. Moreover, and according to a no limitative example of the invention, the pad 20 comprises a steel reinforcement 26 located inside the mixture of concrete 22 and the powdery material 24. The steel reinforcement 26 extends inside the pad 20 along the vertical direction V of the support structure 4. Such a structure of the pad 20 grants a better rigidity to it and participate to the solidity of the support structure 4 to hold the storage tank 2.

The metallic structure 18 comprises a plurality of metal beams 28 assembled together. More precisely, at least one of the metal beam 28 of the metallic structure 18 comprises a “I” shape, viewed in a vertical section of the metallic structure 18. Such a shape of the metal beams 28 allows them to hold a heavy structure like the storage tank 2. The plurality of the metal beams 28 is assembled in a homogenous pattern made of square and diagonal, as show in FIG. 4. More precisely, and according to the example illustrated FIG. 4, four metal beams 28 are assembled to form a square and a fifth metal beam 28 is assembled such that it forms a diagonal of the square. According to the invention, the plurality of the metal beams 28 of the metallic structure 18 comprises the pattern describes above. Such a pattern of the plurality of the metal beams 28 grants to the support structure 4 a better resistance to the heavy storage tank and form a uniform support of the latest.

According to a no limitative example of the invention, the metal beams 28 of the metallic structure 18 are made in an alloy of steel and carbon. Moreover, the metallic structure 18 has a thickness between 400 mm and 1400 mm, the thickness being measured along the vertical direction V of the support structure 4. Such a characteristic means that at least one of the metal beams 28 of the metallic structure 18 comprises a thickness between 400 mm and 1400 mm.

According to the example of the invention shows at FIG. 2, at least two metallic beams 28 of the metallic structure 18 can have different thickness each other.

According to the invention, one metallic sheet 30 is located between the pad 20 and the metallic structure 18. More precisely, the pad 20 comprises a bottom face 32 and an upper face 34, vertically opposite to each other, the bottom face 32 being in front of the metallic structure 18. Moreover, the metallic structure 18 comprises a bottom surface 36 and an upper surface 38, vertically opposite each other and in such a way that the upper surface 38 is facing the bottom face 32 of the pad 20. So, the metallic sheet 30 is located between the bottom face 32 of the pad 20 and the upper surface 38 of the metallic structure 18.

As shown on the FIGS. 2 and 3, the pad 20 comprises a periphery side 40 which joins its bottom face 32 with its upper face 34 and the support structure 4 comprises at least a metallic band 42 installed in contact with the periphery side 40 of the pad 20. In other words, the metallic band 42 cover the periphery side 40 of the pad 20. According to the invention, the metallic sheet 30 and the metallic band 42 are joined together to form a formwork for the pad 20. Moreover, the support structure 4 comprises a sealing material installed in the junction of the metallic sheet 30 and the metallic band 42.

So, according to a no limitative example of the process of fabrication, during the process of fabrication of the support structure 4, the metallic sheet 30 and the metallic band 42 are joined together and are seal together with the sealing material, such that they form a waterproof formwork of the pad 20. Afterwards, the liquid mixture of concrete 22 with the powdery material 24 is poured into the formwork. Then, after the mixture has solidified to form the pad 20, a metallic plate 44 is placed on the upper face 34 of the pad 20.

According to the invention, the support structure 4 comprises the at least one metallic plate 44 located in contact with the upper face 34 of the pad 20. So, the metallic plate 44 is located between the upper face 34 of the pad 20 and the thermal barrier of the bottom wall of the storage tank.

It is understood that the pad 20 is bordered by the metallic sheet 30, the metallic plate 44 and the metallic band 42. According to an example of the invention, the metallic sheet 30, the metallic plate 44 and the metallic band 42 delimited a waterproof volume which comprises the pad 20. Moreover, the metallic sheet 30 and/or the metallic band 42 are made of low temperature carbon steel and the metallic plate 44 is made of stainless steel.

According the example of the invention illustrated at FIG. 3, the support structure 4 comprises at least one anchor stud 45 that extends inside the pad 20. More precisely, the anchor stud 45 extends along the vertical direction V of the support structure 4 and such that it joins the metallic sheet 30 with the metallic plate 44. So, it is understood that the anchor stud 45 participates to the fixation of the metallic plate 44 and the metallic sheet 30 to each other.

According to the invention and as it has been described previously, the storage tank is held by the support structure 4 and is more precisely attached to the support structure 4 by at least one fixing mean 46, illustrated on FIG. 3. The fixing mean 46 is configured to set the storage tank 2 on the support structure 4 and it comprises at least two fixing elements 48. According to the invention, the fixing mean 46 may be a temporary fixing element used during the transport of the support structure 4 and the tank, and may be removed after the said transport.

A first fixing element 48a is a fixing wall 48a which is located outside the internal space of the storage tank and extends from its peripheral wall. The fixing wall 48a comprises also a through hole 50. According to the example illustrated, the fixing wall 48a extends in a plan which is parallel to a main extension plan of the pad 20, perpendicular to the vertical direction V of the support structure 4.

A second fixing element is a screw 48b configured to lay at least in the through hole 50 of the fixing wall 48a. More precisely, the screw 48b is configured to extend through the through hole 50 of the fixing wall 48a and through at least the pad 20. According to the invention, the screw 48b is configured to go through the metallic sheet 30, the pad 20, the metallic plate 44 and the hole 50 of the fixing plate 48a. More precisely the screw 48b go through a vertical hole 51 of the pad 20, close to is periphery side 40.

As illustrated on the FIG. 3, two nuts 52 are screwed at the vertical ends of the screw 48b. More precisely, the nuts 52 are located such that each of them is in contact with the fixing wall 48a and with one of the metallic beam 28 of the metallic structure 18. More precisely, one of the nuts 52 is in contact with the upper surface of one of the metallic beams 28. So, it is clear that the nut 52 participate to block in position the storage tank 2 relative to the support structure 4. According to the invention, the storage structure comprises a plurality of said fixing means 46 which comprise the same characteristics as described above.

It is understood that the support structure 4 comprises a bigger perimeter than a perimeter of the storage tank 2. In other words, and according to an example of the invention illustrated on FIG. 1 and wherein the storage tank 2 has a cylindrical shape and the support structure 4 has a circular shape, a first diameter D1 of the support structure 4 is bigger than a second diameter D2 of the storage tank 2, the diameters being measured relative to a revolution axis R of the said storage tank 2, parallel to the vertical direction V of the support structure 4.

According to the invention illustrated FIG. 3, an epoxy joint 54 may be located between the bottom wall 6 of the tank and the metallic plate 44 such that it forms a gasket between the tank and the support structure 4.

However, the present invention is not limited to the means and configurations described and illustrated herein and extends to any equivalent means and configuration and any technically operative combination of such means.

1. A support structure for a storage tank, the support structure is configured to hold the storage tank by being located at least underneath the storage tank, the support structure comprising:
at least a metallic structure and at least one pad comprising at least concrete mixed with a powdery material, the pad being superimposed on the metallic structure.

2. The support structure as claimed in claim 1, comprising one metallic sheet being located between the pad and the metallic structure.

3. The support structure as claimed in claim 1, wherein the pad comprises an upper face opposite to a bottom face, the support structure comprising at least one metallic plate located on the upper face of the pad.

4. The support structure as claimed in claim 3, wherein the pad comprises a periphery side which joins its bottom face with its upper face, the support structure comprising at least a metallic band located on the periphery side of the pad.

5. The support structure as claimed in claim 2, wherein the metallic sheet and/or the metallic band are made in low temperature carbon steel and the metallic plate is made of stainless steel.

6. The support structure as claimed in claim 5, wherein the pad is bordered by the metallic sheet, the metallic plate and the metallic band.

7. The support structure as claimed in claim 3, comprising one metallic sheet being located between the pad and the metallic structure,
wherein the pad comprises at least one anchor stud which extends along a vertical direction of the support structure and such that the at least one anchor stud joins the metallic sheet with the metallic plate.

8. The support structure as claimed in claim 4, comprising one metallic sheet being located between the pad and the metallic structure, and a sealing material installed in the junction of the metallic sheet and the metallic band.

9. The support structure as claimed in claim 1, wherein the metallic structure comprises a plurality of metal beams assembled together.

10. The support structure as claimed in claim 1, having a thickness between 500 mm and 2000 mm.

11. The support structure as claimed in claim 1, wherein the pad has a thickness between 100 mm and 600 mm.

12. The support structure as claimed in claim 1, wherein the metallic structure has a thickness between 400 mm and 1400 mm.

13. A storage structure comprising a storage tank able to store a liquid and the support structure as claimed in claim 1, the storage tank being hold by the support structure, the storage tank comprises at least a bottom wall in contact with the support structure.

14. The storage structure as claimed in claim 13, wherein at least the bottom wall of the storage tank comprises at least one thermal barrier covered by a metallic membrane, the metallic membrane being designed to be in contact with the liquid.
